(19) United States
(12) Patent Application Publication
(10) Pub. No.: US 2007/0281663 A1
(43) Pub. Date: Dec. 6, 2007

(54) Optimal selection of communications common carrier plans

(75) Inventors: Tuomas Sandholm, Pittsburgh, PA (US); Robert Shields, Pittsburgh, PA (US); Bryan Bailey, Pittsburgh, PA (US); Richard James McKenzie, Butler, PA (US); Michael Pete Rose, Pittsburgh, PA (US); Nick Kuyakanon, Chicago, IL (US); David L. Levine, Chesterfield, MO (US); Subhash Suri, Santa Barbara, CA (US)

Correspondence Address: THE WEBB LAW FIRM, P.C., 700 KOPPERS BUILDING, 436 SEVENTH AVENUE, PITTSBURGH, PA, 15219, US

(73) Assignee: CombineNet, Inc., Pittsburgh, PA (US)

(21) Appl. No.: 11/805,087

(22) Filed: May 22, 2007

Related U.S. Application Data
(60) Provisional application No. 60/810,955, filed on Jun. 5, 2006.

(51) Int. Cl. H04M 11/00

(52) U.S. Cl. 455/406

(57) ABSTRACT

In an allocation of subscribers to one or more wireless carrier rate plans, a number of wireless voice and/or data carrier rate plans is selected and each subscriber's historical wireless time usage for each of a number of foregone time intervals is determined. For each combination of subscriber and rate plan a first expression is defined that includes a unique variable and a cost associated with assigning the subscriber to the rate plan for at least one of the time intervals. Constraints that collectively ensure that subscribers are allocated to a specified minimum or maximum number of rate plans, or restrict a subscriber to be allocated to just one rate plan are determined. The expressions and constraints are processed by an optimal solution solver running on a computer to determine an optimal assignment of subscribers to at least one rate plan.

### CROSS REFERENCE TO RELATED APPLICATIONS

The present application claims priority from U.S. Provisional Patent Application No. 60/810,955, filed Jun. 5, 2006, which is incorporated herein by reference.

### BACKGROUND OF THE INVENTION

1. Field of the Invention

The present invention relates to a novel method of optimally assigning subscribers to wireless calling and data plans.

2. Description of Related Art

Historically, an organization's cellular/wireless calling and data (voice and data) usage and cost or billing information are provided monthly by the wireless telecommunications carrier in the form of an invoice. Such invoice can either be in paper or digital form. Each wireless telecommunications carrier typically has its own unique invoice format—potentially both in paper and in digital form. In addition, each carrier may have several digital forms of invoices.

Each wireless telecommunication carrier's monthly invoice typically includes information regarding cost and usage for each subscriber such as, without limitation, one or more of the following:

Peak minutes;

Off Peak minutes;

Roaming minutes;

Long distance minutes;

Push to talk local minutes;

Push to talk national minutes;

Push to talk international minutes;

Mobile-to-mobile device, in-carrier network calling minutes; and

International minutes.

Each monthly invoice may also include information regarding each subscriber's cost and usage of data services such as, without limitation, one or more of the following:

Text messages;

Short Message (email) Services (SMS);

Picture Messaging

Video Messaging

Kilobyte usage for internet based usage;

web browsing; and

Surcharges related to data services, such as roaming and international use.

In addition to a subscriber's usage, each monthly invoice may also include information regarding, without limitation, one or more of the following:

Rate plan costs;

Rate plan add-ons or features such as discounted calling or data packages for voice or data;

Rate plan discounts

Peak/Off Peak Minute overage costs;

Rate plan usage costs;

Wireless telecommunications carrier surcharges;

Optional and mandated government surcharges;

Credits;

Equipment Charges;

One time and miscellaneous charges; and

Taxes.

Usage and cost information can be for voice plans, data plans or a combination of voice and data plans.

Heretofore, no means has existed for optimally assigning a large number of related subscribers to one or more wireless carrier rate plans based upon the historical usage of said subscribers and the common and unique features of the wireless carrier rate plans. It is believed that, heretofore, the inability to simultaneously consider all of the features of all of the wireless carrier rate plans in view of the subscribers' historical usage prevented such optimal allocation or assignment of subscribers to one or more wireless carrier rate plans. It would, therefore, be desirable to overcome the above problems and others by providing a method that enables an optimal allocation of subscribers to one or more wireless carrier rate plans based upon a desired set of features of each rate plan. Other benefits of the present invention will become apparent to those of ordinary skill in the art upon reading and understanding the following detailed description.

### SUMMARY OF THE INVENTION

A method of allocating subscribers to one or more wireless carrier rate plans includes (a) selecting a plurality of wireless voice and/or data carrier rate plans; (b) determining for each of a plurality of subscribers, said subscriber's historical wireless time or data packet usage for each of a number of foregone time intervals; (c) defining for each combination of subscriber, rate plan, time interval or data packet amount and said subscriber's wireless time usage during said time interval a combination of a unique variable and a cost associated with said wireless usage for said rate plan during said time interval; (d) combining the combinations determined in step (c); (e) defining for each combination of subscriber and time interval a first constraint that defines a limit on the allocation of said subscriber to one of said rate plans during said time interval; and (f) electronically determining as a function of the combination of step (d) and each constraint defined in step (e) an allocation of each subscriber to at least one wireless rate plan.

Step (f) can further include electronically determining a cost associated with said allocation.

Each first constraint can include, for one of the combinations of subscriber and time interval, the additive combination of the corresponding unique variables defined in step (c) for said combination of subscriber and time interval for all of said rate plans.

In step (f), at least one wireless rate plan can be allocated to each combination of subscriber and time interval.

Step (e) can further include defining for each subscriber a second constraint that defines a limit on the allocation of said subscriber to no more than one of said rate plans and defining for each combination of subscriber and rate plan a set of third constraints, with each third constraint of each set thereof corresponding to one of the time intervals, wherein each set of third constraints define a limit on the allocation of said subscriber to said rate plan during all of the time intervals, whereupon in response to step (f) each subscriber is allocated to only one of the rate plans during all of the time intervals

Each time interval can be either a month or other suitable calendar time period or a billing period of one of the wireless carriers.

Another method of allocating subscribers to a wireless carrier rate plan includes: (a) selecting a plurality of wireless voice and/or data carrier rate plans; (b) determining for each of a plurality of subscribers, said subscriber's historical wireless time usage for each of a number of foregone time intervals; (c) defining for each combination of subscriber and rate plan, a combination of a unique variable and a cost associated with said subscriber's wireless usage under said rate plan during all of said time intervals; (d) defining for each time interval, a combination of a unique variable associated with the overage usage of all of the subscribers in said time interval and a cost associated with each unit of overage usage; (e) combining the combinations determined in steps (c) and (d); (f) defining for each subscriber a constraint that includes the unique variables determined for said subscriber in step (c), wherein said constraint defines a limit on the assignment of said subscriber to one of the rate plans; (g) defining for each combination of subscriber, rate plan and time interval, the combination of surplus or overage units of time that would have been realized by said subscriber during said time interval had said subscriber been subscribed to said rate plan during said time interval and the corresponding unique variable from step (c) for said combination of subscriber and rate plan, wherein the surplus or overage units of time for each combination of subscriber, rate plan and time interval is determined from the difference between the subscriber's actual units of time usage during said time interval and the units of time that would have been available for use during said time interval under said rate plan had said subscriber been subscribed to said rate plan during said time interval; (h) defining for each time interval, a constraint that requires the sum of the combinations defined in step (g) for said time interval and the variable defined in step (d) for said time interval to be greater than or equal to zero; and (i) electronically determining as a function of the combination of step (e) and the constraints determined steps (f) and (h) an allocation of all of the subscribers to one of the rate plans.

Step (i) can further include electronically determining a cost associated with said allocation.

Each rate plan can be one where the subscribers assigned thereto share the units of usage of said plan.

Each time interval can be either a month or other suitable calendar time period or a billing period of one of the wireless carriers.

The method can further include defining for each subscriber, a unique variable and a cost associated with assigning said subscriber to the add-a-phone rate plan for all of the time intervals, wherein each constraint of step (f) includes for the corresponding subscriber the unique variable associated with the cost of assigning said subscriber to the add-a-phone rate plan and each constraint of step (h) includes for each subscriber the combination of the unique variable associated with the cost of assigning said subscriber to the add-a-phone rate plan and the surplus or overage units of time that would have been realized by said subscriber during the time interval associated with said constraint had said subscriber been subscribed to said rate plan during said time interval.

Yet another method of allocating subscribers to a wireless carrier rate plan includes: (a) selecting a plurality of wireless voice and/or data carrier rate plans; (b) determining for each of a plurality of subscribers, said subscriber's historical wireless time usage for each of a number of foregone time or data packet intervals; (c) determining for each combination of time interval or data packet and rate plan, a combination of a unique variable associated with the total units of time of usage by all of said subscribers over that allowed by the rate plan during said time interval and a cost associated with each unit of time of usage over that allowed by the rate plan; (d) defining for each rate plan, a combination of a unique variable and a cost associated with purchasing the rate plan for all of the time intervals; (e) combining the combinations determined in steps (c) and (d); (f) defining for each subscriber a constraint that includes a variable for each rate plan, wherein said constraint limits the assignment of said subscriber to one of the rate plans; (g) defining for each combination of time interval, subscriber and rate plan, a combination of said subscriber's time usage during said time interval and the variable determined for said subscriber and rate plan in step (f); (h) defining for each combination of time interval and rate plan a constraint that is a combination of: (1) each combination defined in step (g) for the corresponding time interval and rate plan; (2) the combination of the total units of time available under the rate plan during said time interval and the variable determined in step (d) for the rate plan; and (3) the unique variable determined in step (c); (i) defining for each rate plan a constraint that conditions the allocation of subscribers to the rate plan upon purchase of the rate plan; and (j) electronically determining as a function of the combination of step (e) and the constraints determined steps (f), (h) and (i) an allocation of all of the subscribers to one of the rate plans.

Step (j) can further include electronically determining a cost associated with said allocation.

Each constraint defined in step (h) can include each combination of step (1) subtracted from the sum of the combinations of steps (2) and (3).

The constraint defined in step (i) for each rate plan can includes the variables of step (f) subtracted from the product of 2 times the variable determined in step (d).

Another method of allocating subscribers to one or more wireless carrier rate plans includes receiving an allocation of a plurality of subscribers to at least one wireless carrier rate plan, wherein said allocation is determined by one of the foregoing methods, and subscribing a subset of said subscribers to said at least one wireless carrier rate plan based on the received allocation.

Another method of allocating subscribers to one or more wireless carrier rate plans includes: (a) selecting a plurality of wireless voice and/or data carrier rate plans; (b) determining for each of a plurality of subscribers, said subscriber's historical wireless time usage for each of a number of foregone time intervals; (c) determining for each combination of subscriber and rate plan a first expression that includes a product of a unique variable and a cost associated with assigning said subscriber to said rate plan for at least one of said time intervals; (d) determining a plurality of constraints that collectively (1) ensure that one rate plan is allocated to all of the subscribers or (2) enable any rate plan to be allocated to each subscriber, wherein each constraint includes a sum of expressions each of which includes at least one of the unique variables determined in step (c); (e) entering the expressions and the constraints determined in steps (c) and (d), respectively, into a mixed integer program (MIP) solver residing on computer; (f) causing the computer to execute the MIP solver to minimize the entered expressions as a function the entered constraints, whereupon the MIP solver assigns a binary value of 0 or 1 to each unique variable; and (g) subscribing each subscriber to a rate plan as a function of the binary value assigned to each unique variable associated with said subscriber.

In step (c) each expression can be for all of said time intervals. Step (c) can further include determining for each time interval a second expression that includes the combination of a unique variable associated with overage units of time that would have realized by all of the subscribers under said rate plan during said time interval and a cost of each overage unit of time. For each time interval, a corresponding constraint can be determined therefor in step (d) that includes for each combination of subscriber and rate plan a third expression that is the product of the unique variable associated with said combination in step (c) and the surplus or overage units of time that said subscriber would have realized under said rate plan during said time interval, said constraint further including a sum of all of the third expressions and the unique variable of the second expression determined for said time interval.

In step (c) each first expression can be for all of said time intervals. Step (c) can further include determining for each combination of time interval and rate plan a second expression that includes the product of a unique variable associated with overage units of time that would have realized by all of the subscribers under said rate plan during said time interval and a cost for each overage unit of time. Step (c) can further include determining for each rate plan a third expression that includes a product of a unique variable and a cost to purchase said rate plan for all of said time intervals. For each combination of time interval and rate plan a corresponding constraint can be determined therefor in step (d) that includes for each subscriber during said time interval a fourth expression that is the product of the unique variable associated in step (c) with said subscriber for the rate plan associated with said constraint and the units of time utilized by said subscriber during said time interval, said constraint further including a sum of (1) all of said fourth expressions, (2) the unique variable associated with overage units of time that would have realized by all of the subscribers under said rate plan during said time interval, and (3) a product of the unique variable of the third expression and the total units of time available under said rate plan during said time interval.

### BRIEF DESCRIPTION OF THE DRAWINGS

FIG. 1 is a schematic illustration of a computer system that is capable of implementing the computer software that embodies the present invention;

FIG. 2 is a table showing two subscriber's wireless communication usage for a number of time intervals, namely, January, February, March and April;

FIG. 3 is a table for one subscriber of FIG. 2 showing the cost associated with said user's wireless communication usage for the time intervals shown in FIG. 2 for a number of different wireless carrier plans;

FIG. 4 is a table for other the subscriber of FIG. 2 showing the cost associated with said user's wireless communication usage for the time intervals shown in FIG. 2 for the same wireless carrier plans shown in FIG. 3;

FIGS. 5 and 6 are tables showing the optimal assignment of the subscriber's of FIGS. 3 and 4, respectively, to the common carrier rate plans of FIGS. 3 and 4 for each time interval;

FIG. 7 is a table showing details regarding pool plans, each pool plan's associated base charge and the monthly minutes available under each pool plan;

FIG. 8 is a table showing details regarding bucket plans, each bucket plan's base charge and the monthly minutes available under each bucket plan;

FIG. 9 shows details regarding an add-a-phone plan, and the base charge for adding each additional phone to the pool plans of FIG. 7; and

FIG. 10 is a table showing regular rate plans the base charge associated with each rate plans and the peak pooled monthly minutes of each rate plan, along with a base charge associated with adding each additional phone to one of the listed regular plans.

### DETAILED DESCRIPTION OF THE INVENTION

The present invention is embodied in computer software or computer readable program code that can be executed on a general purpose computer. When executed on a general purpose computer, the present invention is able to optimally allocate any number of subscribers of communications services to common carrier plans, based on usage history, to provide a lower cost solution for their service usage.

The present invention finds particular application in connection with organizations that have a corporate (funded) liable wireless/cellular communication program. Each such organization determines which wireless carrier or provider (one or more) they will select based on their internal business needs related to service, cellular signal coverage, cost drivers, individual subscriber's needs as well as satisfying the organization's communication policies. Each wireless telecommunication carrier rate plan has its own unique way of describing how its service is used and a list of terms that define the costs of using their service. At any one time, there is a large number (e.g., over 100) of standard voice plans to choose from in the market for an organization to assign one or more subscribers.

In order to deal with each carrier's market strategies of their service offering that constitutes the carriers' wireless rate plans, the present invention defines a flexible and extensible rate plan data model that is configured to accept each wireless telecommunication's rate plan idiosyncrasies or strategies, service attributes and capabilities.

The flexibility of the present invention enables wireless telecommunications carrier rate plan changes to be added or removed from consideration as required. This flexibility enables the optimization process to select the present attributes that represent the subscriber's usage model. These selected attributes are then reflected in the choices within the optimization model which then associates an optimal cost effective rate plan based on the subscriber's rate plan attributes and usage. This universal data model is designed in a way that enables it to be seamlessly expanded as the features in the cellular voice and data market expand. It also accounts for the removal of attributes in the data model once those features are no longer available in the market place.

The present invention is an optimization process that considers the historic usage of a set of subscribers over one or more foregone months. It includes a global optimization to determine the lowest total cost for providing service to all of those subscribers. Its output is a set of binary values that correlate to an assignment of each subscriber to a specific wireless plan.

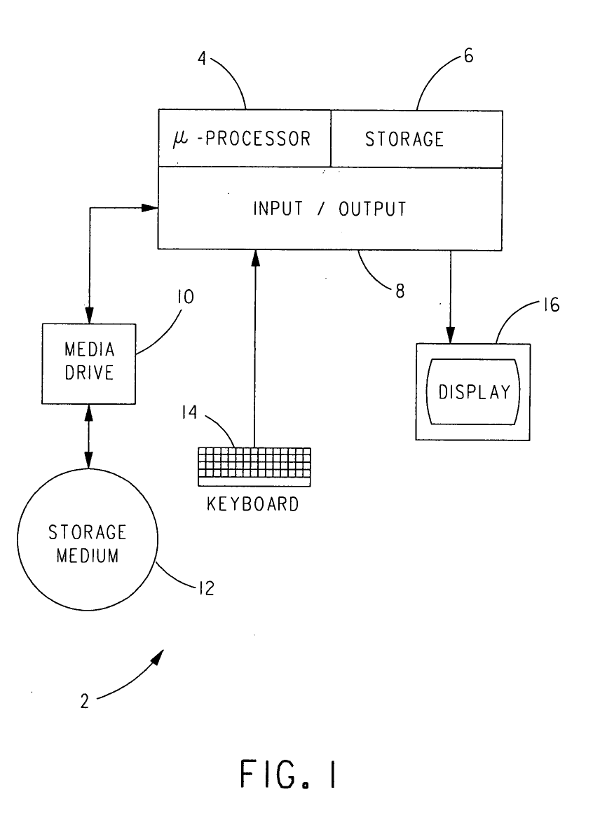

With reference to FIG. 1, the present invention is embodied in computer software which operates on a computer system 2 in a manner known in the art. Computer system 2 includes one or more microprocessors 4, a storage 6 and an input/output system 8. Computer system 2 can also include a media drive 10, such as a disk drive, CD-ROM drive, and the like. Media drive 10 can operate with a computer-usable storage medium 12 capable of storing the computer-readable program code comprising the computer software which embodies the approximate solution algorithm, which computer-readable program code is able to configure and operate computer system 2 in a known manner. Input/output system 8 can include a keyboard 14 and/or a display 16. Computer system 2 is exemplary of computer systems capable of executing the computer software that embodies the present invention and is not to be construed as limiting the invention.

Examples of the optimization process will now be described with reference to the following scenarios and the accompanying figures.

Flat Rate Plans—Free Assignment Scenario:

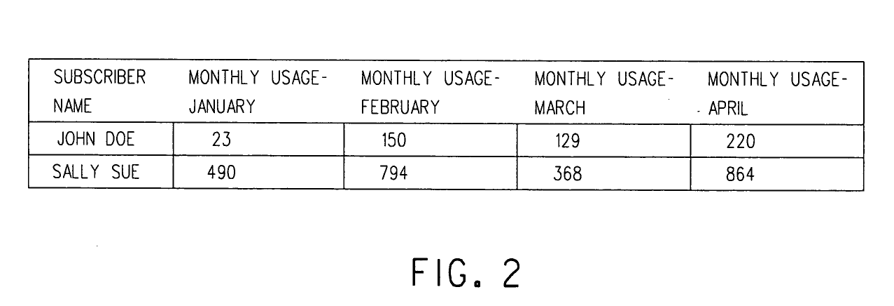

With reference to FIG. 2, suppose two subscribers, John Doe and Sally Sue, have the wireless usage shown for the months (or time intervals) of January, February, March and April:

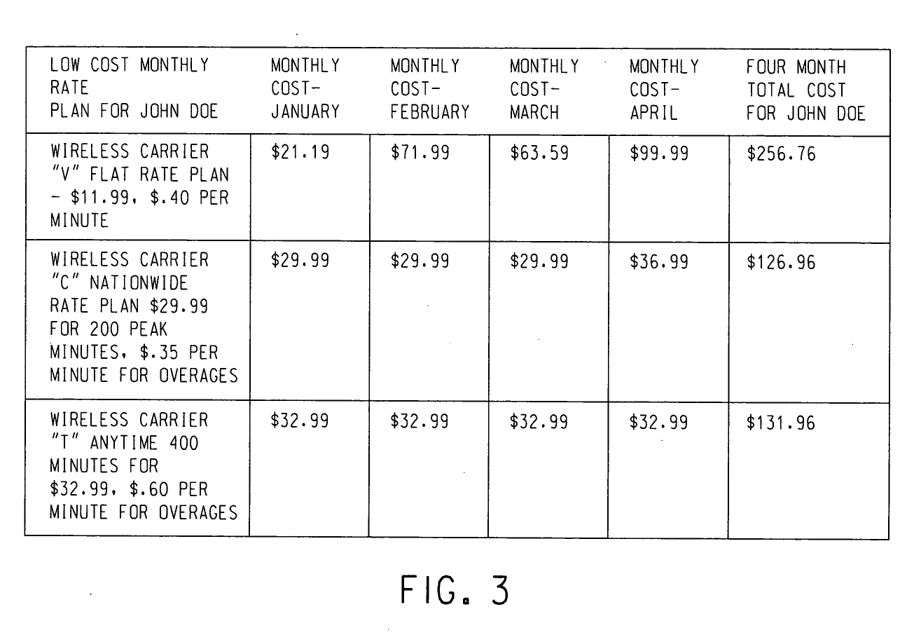

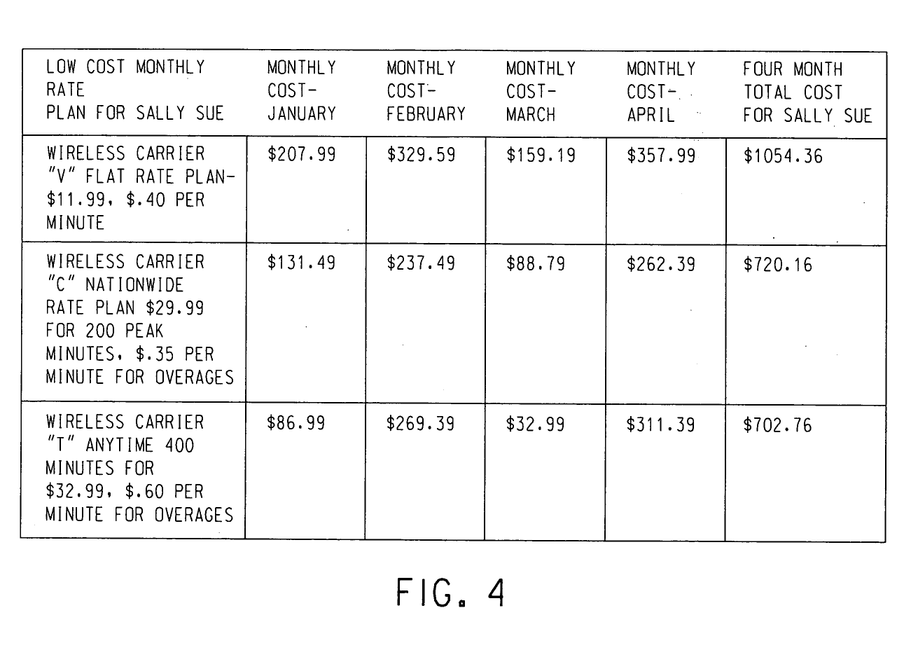

With reference to FIGS. 3 and 4 and with continuing reference to FIG. 2, based on this usage, the tables shown in FIGS. 3 and 4 can be compiled for John Doe and Sally Sue, respectively, for the candidate wireless rate plans listed in each table.

In the analysis of John Doe's and Sally Sue's usage, the computer software of the present invention would determine, by way of solving an optimization problem (described next), which wireless rate plan has the lowest cost per month. The optimization is global across all subscribers under consideration (in this example, for both John Doe and Sally Sue), and considers every candidate wireless rate plan.

The optimization problem is formulated as a Mixed Integer Program (MIP) with the following objective function:

Minimize the sum of 21.19(x1)+71.99(x2)+63.59(x3)+99.99(x4)+29.99(x5)+29.99(x6)+

29.99(x7)+36.99(x8)+32.99(x9)+32.99(x10)+32.99(x11)+32.99(x12)+

207.99(x13)+329.59(x14)+159.19(x15)+357.59(x16)+131.49(x17)+237.89(x18)+

88.79(x19)+262.39(x20)+86.99(x21)+269.39(x22)+32.99(x23)+311.391(x24)

and the following set of linear constraints:

c1:x1+x5+x9=1

c2:x2+x6+x10=1

c3:x3+x7+x11=1

c4:x4+x8+x12=1

c5:x13+x17+x21=1

c6:x14+x18+x22=1

c7:x15+x19+x23=1

c8:x16+x20+x24=1

where each variable, xi (where i=1, 2, . . . , etc.), represents the assignment of a particular subscriber to a particular wireless rate plan in a particular month. For example, variables x1-x4 represent the assignment of John Doe to the Wireless Carrier “V” Flat Rate Plan in January, February, March and April, respectively; variables x13-x16 represent the assignment of Sally Sue to the Wireless Carrier “V” Flat Rate Plan in January, February, March and April, respectively; and so forth. The coefficient in front of each variable in the objective function represents the cost that would have been realized had the subscriber been assigned to the wireless rate plan in the corresponding month.

Constraints c1 through c8 ensure that each subscriber is assigned to only one wireless rate plan. For example, constraint c1 restricts John Doe to be assigned to only one of the Wireless Carrier “V”, Wireless Carrier “C”, and Wireless Carrier “T” plans, in January. Constraints c2 through c4 are analogous for the months of February, March, and April, respectively, for John Doe, while constraints c5 through c8 are analogous for Sally Sue for the months of January through April, respectively.

The foregoing MIP can be solved with any commercially available MIP solver, such as the CPLEX® optimizer available from ILOG, Inc., 1080 Linda Vista Avenue, Mountain View, Calif. 94043, or the Xpress-MP™ optimizer available from Dash Optimization, Inc., 560 Sylvan Avenue, Englewood Cliffs, N.J. 07632. In the U.S., CPLEX® is a Registered Trademark, Registration No. 1790210, of ILOG, Inc.

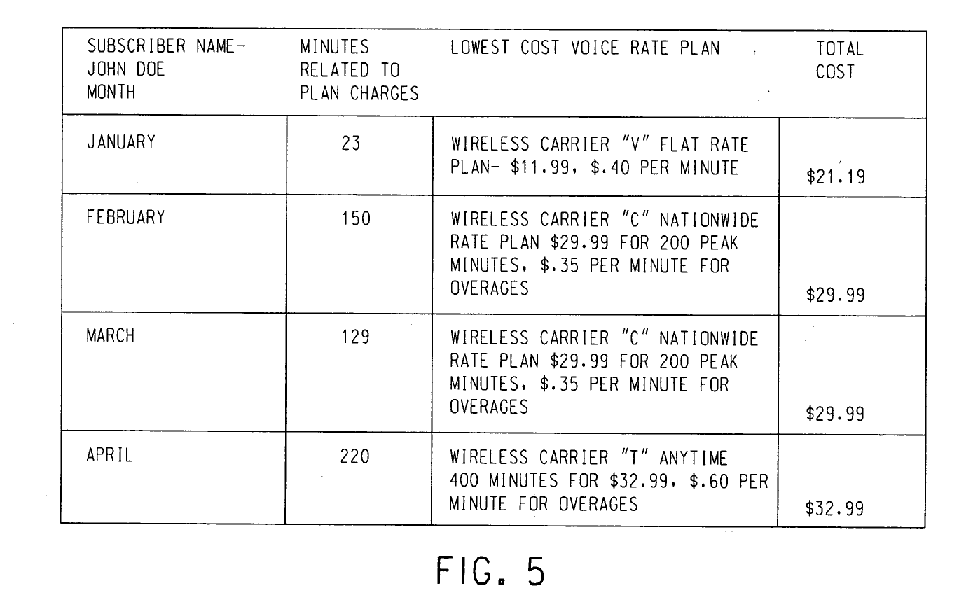

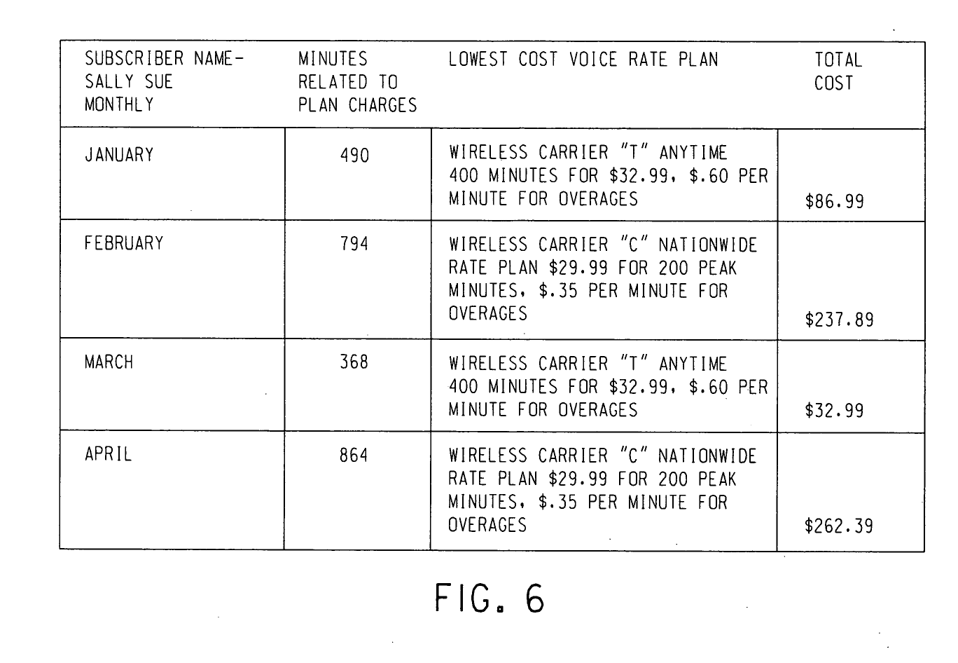

With reference to FIGS. 5 and 6 and with continuing reference to all previous Figs., solving the forgoing MIP utilizing a commercially available MIP solver results in a binary value of 1 being assigned to each of the following variables: x1, x6, x7, x12, x18, x20, x21, and x23. Each of the other variables is assigned a value of 0. These assignments for the months of January-April for John Doe (x1, x6, x7 and x12) and Sally Sue (x18, x20, x21, and x23 are as shown in FIGS. 5 and 6, respectively.

Flat Rate Plans-All Time Intervals Required Assignment Scenario:

From a cost standpoint, it may be impractical for a subscriber to change wireless rate plans within a contract period due to cancellation charges associated with each plan. However, it may be beneficial to allow a subscriber to switch wireless carrier rate plans if it can be determined that it is more cost effective to change a subscriber's rate plan and pay the cancellation charges versus not changing wireless rate plans. Accordingly, in contrast to permitting the MIP solver to freely assign a rate wireless plan to a subscriber in a particular month, it would be desirable that the MIP solver only assign one wireless rate plan to each subscriber for a number of months (or time intervals). To this end, in order to determine which wireless rate plan to allocate to each subscriber, the following additional constraints are added to the set of linear constraints that the MIP solves:

For John Doe:

c9:x1−x25≦0

c10:x2−x25≦0

c11:x3−x25≦0

c12:x4−x25≦0

c13:x5−x26≦0

c14:x6−x26≦0

c15:x7−x26≦0

c16:x8−x26≦0

c17:x9−x27≦0

c18:x10−x27≦0

c19:x11−x27≦0

c20:x12−x27≦0

c21:x25+x26+x27≦1

### For Sally Sue:

c22:x13−x28≦0

c23:x14−x28≦0

c24:x15−x28≦0

c25:x16−x28≦0

c26:x17−x29≦0

c27:x18−x29≦0

c28:x19−x29≦0

c29:x20−x29≦0

c30:x21−x30≦0

c31:x22−x30≦0

c32:x23−x30≦0

c33:x24−x30≦0

c34:x28+x29+x30≦1

In constraints c9 through c34 above, binary variables x1-x24 have the same meanings as discussed above, binary variables x25, x26 and x27 represent the assignment of John Doe to the Wireless Carrier “V” plan, the Wireless Carrier “C” plan and the Wireless Carrier “T” plan, respectively, and binary variables x28, x29 and x30 represent the assignment of Sally Sue to the Wireless Carrier “V” plan, the Wireless Carrier “C” plan and the Wireless Carrier “T” plan, respectively. The sum of variables x25, x26 and x27 that represent the assignment of John Doe to a wireless rate plan is constrained (c21) to be less than or equal to 1. This constraint (c21) forces John Doe to be allocated only one of the wireless rate plans. Similarly, constraint c34 forces Sally Sue to be allocated only one of the wireless rate plans.

Plan Pooling Scenario:

As part of the wireless rate plan selection process, the MIP formulation can guide the MIP solver to determine if two or more subscribers can be grouped together. The process of grouping subscribers is called pooling. The wireless service market as defined by the wireless telecommunication providers has created several forms of pooling that the present invention can optimize as follows:

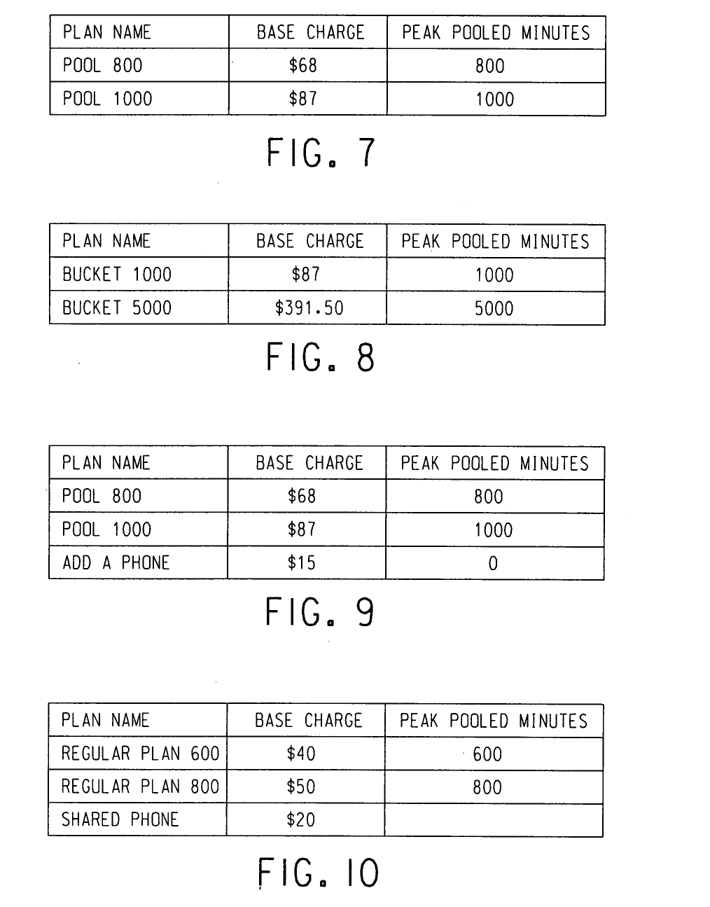

With reference to FIG. 7, in plan pooling, each subscriber is assigned to a single wireless rate plan with a specific usage. However the total minutes in the group of wireless rate plans assigned to all of the subscribers can be pooled. Plan Pooling works very similarly to Individual Plans. The only distinction is that every subscriber in a pooled wireless rate plan will share their minutes with all other members of the pool.

Example: Suppose a carrier has 2 wireless rate plans that facilitate pooling peak voice minutes and that 4 subscribers purchase (i.e., are allocated) two rate plans that have 1000 Peak Pooled Minutes and two rate plans that have 800 Peak pooled Minutes whereupon the four subscribers have a total of 3600 minutes (2×1000+2×800) between them which can be pooled.

Given the base charge shown in FIG. 7 for each plan, the total base cost for the subscribers is $310 (2*87+2*68).

In the instance where we have the subscribers John Doe and Sally Sue with usages described above, where a subscriber must be assigned to the same wireless rate plan for four months, the only available wireless rate plans are the Pool 1000 (with cost $87/month) and Pool 800 (with cost $68/month), and subscribers assigned to a pool may use minutes in excess of those granted by the pool at a rate of $0.10/minute, the optimization problem is formulated as a Mixed Integer Program (MIP) with the following objective function:

Minimize the sum of: 272(x1)+348(x2)+272(x3)+348(x4)+0.10(x5)+0.10(x6)+0.10(x7)+0.10(x8)

and linear constraints:

c1:x1+x2=1

c2:x3+x4=1

c3:777(x1)+977(x2)+310(x3)+510(x4)+(x5)>=0

c4:650(x1)+850(x2)+6(x3)+206(x4)+(x6)>=0

c5:671(x1)+871(x2)+432(x3)+632(x4)+(x7)>=0

c6:580(x1)+780(x2)−64(x3)+136(x4)+(x8)>=0

The encoding of the forgoing MIP is as follows:

Variables x1 and x2 are associated with the assignment of John Doe to the Pool 800 plan and the Pool 1000 plan, respectively, for the four-month period of FIG. 2, i.e., January, February, March and April. Variables x3 and x4 are associated with the assignment of Sally Sue to the Pool 800 plan and the Pool 1000 plan, respectively, for the four-month period. The MIP solver assigns either a value of 0 or 1 to each of these variables.

Variables x5 . . . x8 represent for the four-month period of FIG. 2, i.e., January, February, March and April, respectively, the number of minutes that are used by all of subscribers in each month over the total amount allocated to the pool for that month, i.e., overage minutes. For example, x5 is associated with the number of overage minutes in Jan.

The coefficients of variables x1-x8 in the objective function represent either the cost of assigning a subscriber to a plan for the four month period (x1-x4) or the overage cost per minute of the pool, (x5-x8) respectively. For example, for x1, the coefficient 272=(4 months)($68 per month charge for Pool 800 plan). For x5, the coefficient 0.10 is the cost per minute for any overage minutes in Jan. Similarly for x6-x8 for February-April, respectively.

Constraints c1 and c2 ensure that each subscriber is assigned to only one wireless rate plan. Specifically, constraint c1 restricts John Doe to being allocated to only one pool plan, namely, Pool 800 plan (x1) or Pool 1000 plan (x2). Similarly for Sally Sue and constraint c2 for Pool 800 plan (x3) or Pool 1000 plan (x4).

Each constraint c3 . . . c6 ensures that for each month, January, February, March, and April, respectively, the total number of minutes available to the pool plus the total number of overage minutes used by the pool is greater than or equal to the total number of minutes used by subscribers in the pool. For example, constraint c6(for April) has constants 580, 780, −64 and 136 associated with variables x1-x4, respectively. Constant 580 (associated with x1) is the number of surplus minutes John Doe would have in April if he were assigned to the Pool 800 plan, i.e., 800-220 (See FIG. 2). Constant 780 (associated with x2) is the number of surplus minutes John Doe would have in April if he were assigned to the Pool 1000 plan, i.e., 1000-220 (See FIG. 2). Constant −64 (associated with x3) is the number of overage minutes Sally Sue would have in April if she were assigned to the Pool 800 plan, i.e., 800-864 (See FIG. 2). Lastly, constant 136 (associated with x4) is the number of surplus minutes Sally Sue would have in April if she were assigned to the Pool 1000 plan, i.e., 1000-864 (See FIG. 2). x8 is the overage minutes for all subscribes for April. Similarly for c3-c5 for January, February, and March with overage minutes x5, x6 and x7, respectively.

In the example of John Doe and Sally Sue above, the MIP solver, a.k.a. the optimizer, would assign the value of 1 to the variables: x1 and x3. Each other variable would be assigned a value of 0. The interpretation of this solution is that both John Doe and Sally Sue are assigned to Pool 800 for the four month period, for a total cost of $544. As the total usage of the two does not exceed 1600 minutes in any month, no pool overage charges are necessary.

Buckets of Minutes Pooling Scenario:

With reference to FIG. 8, in buckets of minutes pooling, there is a tier structure of specific groupings of minutes for a set base price. For every subscriber that is included in this option, there may be a per phone/device charge attached to the final cost. Any number of buckets may be purchased and any number of subscribers can be included in each bucket of minutes. For example, one could buy five 1000-minute buckets or one 5000-minute bucket and the same number of minutes would be utilized. The difference is that with the five 1000-minute buckets, there are 5 total pools each having a specific number of subscribers in each pool. In contrast, with the one 5000-minute bucket, all subscribers would be part of a single pool.

Example: Suppose a carrier has the two plans shown in FIG. 8. In the instance where subscribers John Doe and Sally Sue have the usages shown in FIG. 2, where a subscriber must be assigned to the same wireless rate plan for four months, the only available plans are the Bucket 1000 (with cost $87/month) and the Bucket 5000 (with cost $391.50/month), there is no per-phone/device charge for including a subscriber in this option, and subscribers assigned to a pool may use minutes in excess of those granted by the pool at a rate of $0.10/minute, the optimization problem is formulated as a MIP with the following objective function:

Minimize the sum of: 0(x1)+0(x2)+0(x3)+0(x4)+0.10(x5)+0.10(x6)+0.10(x7)+0.10(x8)+348(x9)+0.10(x10)+0.10(x11)+0.10(x12)+0.10(x13)+1566(x14)

and linear constraints:

c1:x1+x2=1

c2:x3+x4=1

c3:−23(x1)−490(x3)+(x5)+1000(x9)>=0

c4:−150(x1)−794(x3)+(x6)+1000(x9)>=0

c5:−129(x1)−368(x3)+(x7)+1000(x9)>=0

c6:−220(x1)−864(x3)+(x8)+1000(x9)>=0

c7:−(x1)−(x3)+2(x9)>=0

c8:−23(x2)−490(x4)+(x10)+5000(x14)>=0

c9:−150(x2)−794(x4)+(x11)+5000(x14)>=0

c10:−129(x2)−368(x4)+(x12)+5000(x14)>=0

c11:−220(x2)−864(x4)+(x13)+5000(x14)>=0

c12:−(x2)−(x4)+2(x14)>=0

The encoding of the Buckets of Minutes Pooling MIP is similar to the Plan Pooling Mixed Integer Program (MIP) described above, with the addition of variables x9 and x14 which represent purchasing a Bucket 1000 plan and purchasing a Bucket 5000 plan, respectively. For x9 in the objective function, the constant 348=(4 months)($87 per month charge for Bucket 1000 plan). For x14 in the objective function, the constant 1566=(4 months)($319.50 per month charge for Bucket 5000 plan).

The variables x1 and x3 now represent the assignment of John Doe and Sally Sue, respectively, to a Bucket 1000 Plan for the months of January, February, March and April, and x2 and x4 represent the assignment of John Doe and Sally Sue, respectively, to a Bucket 5000 Plan for the months of January, February, March and April. The constant “0” preceding each of x1-x4 in the objective function implies that there is no cost associated with assigning John Doe and Sally Sue to either plan.

Variables x5 . . . x8 represent the overage minutes in January, February, March, and April for all subscribers assigned to the Bucket 1000 plan, while variables x10 . . . x13 represent the overage minutes in January, February, March, and April for all subscribers assigned to the Bucket 5000 plan.

Constraints c1 and c2 ensure that each subscriber (in the present example, John Doe and Sally Sue) is assigned to only one wireless rate plan. Constraints c3 . . . c6 are the surplus/deficit constraints for the Bucket 1000 plan for the months of January, February, March, and April, respectively, for all subscribers assigned to the Bucket 1000 plan, and each constraint c3-c6 includes a term for the number of minutes provided in a particular month from the purchase of minutes from the plan. For example, constraint c3 for the month of January includes the constants −23 and −490 associated with variables x1 and x3 for the minutes used in January by John Doe and Sally Sue, respectively, the variable x5 is for the overage minutes in January, and the constant 1000 associated with variable x9 is for the total number of minutes available in the Bucket 1000 plan in the month of Jan. Similarly for constraints c4-c6 for the surpluses/deficits in the Bucket 1000 plan in February, March and April and constraints c8-c11 for the surpluses/deficits in the Bucket 5000 plan in January, February, March and April.

Constraint c7 ensures that no subscribers are assigned to the Bucket 1000 plan unless the Bucket 1000 plan has been purchased. Similarly, constraint c12 ensures that no subscribers are assigned to the Bucket 5000 plan unless the Bucket 5000 plan has been purchased.

Given the above MIP, the MIP solver would assign the value of 1 to the following variables: x1, x3 and x9; would assign a value of 84 to x8; and a value of 0 to each other variable. The interpretation of this solution is that one Bucket 1000 plan is purchased, and both John Doe and Sally Sue are assigned to this bucket for the four month period, for a total cost of $348. As the total usage of the two exceeds 1000 minutes only in April, overage charges of $0.10*(0+0+0+84)=$8.40 also apply.

Add a Phone Scenario:

With reference to FIG. 9, in an Add a Phone wireless rate plan, the total number of minutes that are needed in a pool is determined assuming there are a defined plurality of wireless rate plans from which to choose to obtain that total. Unlike Plan Pooling, it is not necessary to assign a specific subscriber to a specific wireless rate plan. Instead any number of these wireless rate plans can be chosen and subscribers added to share the total number of minutes and a fee is paid for any extra subscriber who is added into the pool.

Example: Suppose a carrier has the three plans shown in FIG. 9. In the instance where subscribers John Doe and Sally Sue with usages shown in FIG. 2 above; where each subscriber must be assigned to the same plan for four months; the only available plans are the Pool 1000 (at $87/month), Pool 800 (at $68/month), and Add-A-Phone (at $15/month); and subscribers assigned to a pool may use minutes in excess of those granted by the pool at a rate of $0.10/minute, the optimization problem is formulated as a MIP with the following objective function:

Minimize the sum of: 272(x1)+348(x2)+272(x3)+348(x4)+0.10(x5)+0.10(x6)+0.10(x7)+0.10(x8)+60(x9)+60(x10)

and linear constraints:

c1:(x1)+(x2)+(x9)=1

c2:(x3)+(x4)+(x10)=1

c3:777(x1)+977(x2)+310(x3)+510(x4)+(x5)−23(x9)−490(x10)>=0

c4:650(x1)+850(x2)+6(x3)+206(x4)+(x6)−150(x9)−794(x10)>=0

c5:671(x1)+871(x2)+432(x3)+632(x4)+(x7)−129(x9)−368(x10)>=0

c6:580(x1)+780(x2)−64(x3)+136(x4)+(x8)−220(x9)−864(x10)>=0

c7:(x1)+(x2)+(x3)+(x4)−(x9)−(x10)>=0

The encoding of the objective function is the same as in the Plan Pooling MIP discussed above, with the addition of variables x9 and x10 which represent the assignment of John Doe and Sally Sue, respectively, to the Add-A-Phone plan for January, February, March and April. The constant 60 preceding variable x9 represents the cost of the Add-A-Phone plan for John Doe for January, February, March and April, i.e., $60=(4 months)($15/month). Similarly, the constant 60 preceding variable x10 represents the cost of the Add-A-Phone plan for Sally Sue for January, February, March and April.

Constraints c1 and c2 ensure that each subscriber is assigned to only one plan. Specifically, constraint c1 restricts John Doe to being allocated to only one pool plan, namely, the Pool 800 plan (x1), the Pool 1000 plan (x2), or the Add-a-Phone plan (x9). Similarly, for Sally Sue and constraint c2 for the Pool 800 plan (x3), the Pool 1000 plan (x4), or the Add-a-Phone plan (x10).

Constraints c3-c6 ensure that for the months of January, February, March, and April, respectively, the total number of pool plan minutes available to the pool plus the total number of overage minutes used by the pool is greater than or equal to the total number of minutes used by subscribers in the pool. For example, constraint c6(for April) has constants 580, 780, −64 and 136 associated with variables x1-x4, respectively. Constant 580 (associated with x1) is the number of surplus minutes John Doe would have in April if he were assigned to the Pool 800 plan, i.e., 800-220 (See FIG. 2). Constant 780 (associated with x2) is the number of surplus minutes John Doe would have in April if he were assigned to the Pool 1000 plan, i.e., 1000-220 (See FIG. 2). Constant −64 (associated with x3) is the number of overage minutes Sally Sue would have in April if she were assigned to the Pool 800 plan, i.e., 800-864 (See FIG. 2). Constant 136 (associated with x4) is the number of surplus minutes Sally Sue would have in April if she were assigned to the Pool 1000 plan, i.e., 1000-864 (See FIG. 2). x8 is the overage minutes for all subscribes for April. Constant −220 associated (associated with x9) is the number of overage minutes attributable to John Doe in April if he were assigned to the Add-a-Phone plan, while constant −864 (associated with x10) is the number of overage minutes attributable to Sally Sue in April if she were assigned to the Add-a-Phone plan. Similarly for c3-c5 for January, February, and March with overage minutes x5, x6 and x7, respectively.

Constraint c7 ensures that no Add-A-Phone plan is assigned unless at least one subscriber is assigned to a pooling plan (Pool 800 or Pool 1000 plan).

Given the above MIP, the MIP solver would assign the value of 1 to the variables: x1 and x10; would assign the value of 144 to x6; and would assign the value of 284 to x8. Each other variable is assigned the value of 0. The interpretation of this solution is that John Doe would be assigned to Pool 800 and Sally Sue would be assigned to the Add-A-Phone plan for this pool. The total plan costs are $272 (4 months×$68/month)+$60 (4 months×$15/month)=$332. In January and March, the total usage of the pool is less than the 800 minutes allowed, so there is no overage. In February, the total usage of the two subscribers is 944 minutes, so 144 minutes of overage are used. In April, the total usage of the two subscribers is 1084, so 244 minutes of overage are used. The total overage costs are $0.10*(0+144+0+244)=$28.80.

Shared Plans Scenario:

With reference to FIG. 10, in a Shared Plan, a subscriber may add a specific number of phones/devices to a single defined wireless rate plan. These subscribers share the minutes inside the existing plan. For every subscriber that is included in this option there is a specific per phone charge attached to the final cost.

Example: Suppose a carrier has the two shared wireless rate plans shown in FIG. 10. Further, suppose there are 5 total subscribers and one subscriber purchases a 600 minute per month plan and another subscriber purchases an 800 minute per month plan. Two additional subscribers can then be added to the 800 minute plan and one additional subscriber can be added to the 600 minute plan. After the foregoing, there are now three subscribers under the 800 minute plan and 2 subscribers under the 600 minute plan. Subscribers in the 800 minute plan cannot utilize minutes in the 600 minute plan, and vice versa.

The total base cost for the 5 subscribers is $150.00 (40+(2*20)+50+(1*20)).

Just as a single subscriber optimization process can determine what the lowest cost rate plan is for one or more months of usage, the pooling process for the shared plan is very similar with two exceptions. As shown, each pooling shared plan has its own type of subscriber grouping and each subscriber shares the same minutes as a primary subscriber. The present invention allows for the plan's grouping properties and the outcome of the pooling process to determine which subscribers should belong to what type of pooling process at the lowest possible cost. By default, the present invention determines the lowest cost subscriber pooling plan (multiple subscribers in either a single pool or in multiple pools) and type for more than one subscriber group, the type of pooling plan they should be assigned to and which subscribers should be grouped together.

Often, as part of the optimization process, there may be one or more pooling groups for four or more subscribers that are based on the usage for the subscribers in each defined group. (Pooling requires at least 2 subscribers in a pool)

In summary, the present invention determines whether it is cost effective to group or select a pooling method with more than one subscriber together and, if so, the following must be true:

A group of subscribers placed in an optimal pool with a defined pooling structure must have a lower cost than any other pooling for the selected subscribers; and

The group of pooled subscriber's total cost must be lower than the sum of the same group of subscribers' single lowest plan cost.

Conditional Discounts:

The present invention can also facilitate the incorporation of conditional discount offers into the optimization model (or MIP formulation) for organizations that sign a contract commitment to a wireless telecommunication provider. Examples of conditional discounts include: (1) one based on a achieving a subscriber volume level of business, (2) the second is meeting a corporate volume level of monetary level of business (dollar volume) or a monetary volume commitment discount and (3) the third is a flat rate discount.

The subscriber volume discount is based on a carrier being awarded a certain number of subscribers. These discounts can be tiered whereupon the more subscribers awarded to a carrier the greater the discount. For example:
If wireless carrier X is awarded 10 Subscribers, apply a rate discount of 8.00 percent
If wireless carrier X is awarded 100 Subscribers, apply a rate discount of 10.00 percent
If wireless carrier X is awarded 500 Subscribers, apply a rate discount of 12.00 percent
If wireless carrier X is awarded 1,000 Subscribers, apply a rate discount of 15.00 percent
If wireless carrier X is awarded 5,000 Subscribers, apply a rate discount of 17.00 percent
If wireless carrier X is awarded 15,000 Subscribers, apply a rate discount of 20.00 percent

The monetary volume commitment discount requires an organization to spend a certain amount of business with a wireless telecommunications service carrier before a discount can be applied. These discounts can be tiered whereupon the more subscribers awarded to a carrier the greater the discount. The amount upon which these discounts are based is called a Minimum Revenue Commitment (MRC). For example:
If my organization awards wireless carrier Y $1,000,000 to $2,000,000 of business then apply a discount of 10.00 percent
If my organization awards wireless carrier Y $2,000,000 to $4,000,000 of business then apply a discount of 12.00 percent
If my organization awards wireless carrier Y $4,000,000 to $8,000,000 of business then apply a discount of 14.00 percent

The flat rate discount is a discount that is provided by the wireless telecommunication carrier to an organization. This discount is a general or flat rate discount that is given to an organization if they do business with the carrier or are awarded the business for one or more subscribers. The only commitment to obtain this discount is to do business with the carrier. For example:
If awarded any business, apply my corporate discount of 12.50 percent from Wireless carrier Z

The present invention can also facilitate unique discount structures per rate plan type or device type. For example, separate discounts can be allocated for data devices and voice based devices, or voice rate plans versus data or data packet rate plans.

For each subscriber, one or more discount types may be incorporated in the MIP. If the discounts are incorporated or allowed in the MIP, the MIP solver will determine which is the optimal discount type and level or tier. Or rather, if feasible, the MIP solver will select the discount level within the discount structure that offers the largest incentive or total lowest cost for all subscribers. Multiple discounts and multiple types of discounts can be applied in one allocation.

Wireless telecommunication carrier discounts can also apply to different groups in an organization or a subscriber group. An example of different groups within an organization would be a business group. Therefore, conditional discounts can be based on properties other than the number of subscribers, monetary commitments, or general business requirements. The discounts could be based on, for example, without limitation, the one or more of the following which can be encoded into an MIP:
Key Geographic Locations or Regions for a carrier
Business Division, Group, Operating Company
Business Brand
Service Locations
Business Department (including, but not limited to:)
Sales
Internal or External Service
Operations
Corporate or Headquarters
Marketing
Executive
Transportation
Technology
Accounting Groups also known as Cost Entities
Data Device(s)
Voice Based Device(s)
Voice Rate Plan(s)
Data Plan(s)
Data Packet Rate Plan(s)

Side Constraints:

If desired, one or more of the following so-called side constraints, that impose an additional restriction or limitation on the outcome determined by the MIP solver, can also be encoded into the MIP formulation:
Min/max number of carriers
Upper/lower number or percentage of subscribers assigned to a carrier and/or plan
Upper/lower $ amount assigned to a carrier
Favor/penalize a particular carrier (weighting)
Mass Migration of subscribers to a particular carrier and/or plan
Keep one or more subscribers with a particular carrier and/or plan
Set upper and lower bounds of the number of plans awarded in total
Set the plan(s) to be awarded
Business changes (e.g., purchase handsets, termination fee(s), activation fee(s), etc.)
Keep one or more subscribers with a particular carrier and/or plan if the cost to change exceeds a predetermined amount

Scenario Demand (modifies each subscriber's usage or consumption pattern to accommodate changes in the future demand of minutes, kilobytes, short message usage, picture message and text messages usage and text message usage);

Discount minutes (e.g., free in-carrier calls);
Ensure handset capabilities remain the same (e.g., Push to Talk functionality, web browsing, data services, etc.);
Ensure discounted or free minutes are translated in to a similar plan (e.g., In network calls, free off peak minutes);
Roaming (e.g., when considering a switch from a national call plan to the local call plan, the number of premium minutes must be considered);
Features (e.g., add-ons such as buy roaming versus changing plan to one with roaming; buy text messaging plans versus paying for text messaging time/usage); and
Signal Strength by carrier (e.g. determines the optimal carrier based on the carrier's minimal signal strength percentage or number for a subscriber's geographic calling profile.

User Defined Pooling Structures.

In order to collectively group or pool voice and or data minutes (i.e., text, IP, etc.) together, the MIP formulation must be coded to represent group plans, subscriber's minutes and subscribers together.

When a plan is defined in a carrier rate plan data model, a single rate plan is defined if it has the ability to pool or share minutes with another plan. If a plan has pooling or sharing capability, or both, it then is defined as to what type of pooling it can perform within the carrier's billing/subscriber usage system. A single rate plan may have several different pooling types that may be purchased as an individual or single subscriber plan.

The second part of determining the modeling of a plan is to determine what other plans can be linked together and, if they are linked together, whether they are to share the same type of pooling properties. Pooling plans that have the same pooling properties are to be known as a pooling group.

During optimization by the MIP solver, pooling plans that have the same pooling linkage will be analyzed against two or more subscribers. If two or more subscribers are determined to be pooled together, then they must be pooled with plans that have direct linkage or within the same pooling plans. Subscribers that are pooled together must always belong in the same pooled group.

Subscriber Rate Plan Pooling Optimization Selection.

The MIP can be formulated to guide the MIP solver to allocate pooling structures during the optimization process. The MIP formulation can also be coded whereupon it guides the MIP solver to determine if one or more subscribers can be included in one or more pooling structures.

During optimization, the MIP formulation can guide the MIP solver to quantify if a subscriber should be on a single plan or on a pooling plan, provided pooling plans are permitted to be incorporated in the optimization. The MIP solver, as controlled by the formulation, will determine, based on service costs and a subscriber's usage profile, if the subscriber should be on a single plan or in a pooling plan with one or more subscribers. The optimization process will not only look at a single plan for a single subscriber but will also determine if one or more subscribers can be grouped or pooled together based on the pooling types available.

Automated Implementation of Project Plans Based on a User Defined Allocation.

The MIP formulation guides the MIP solver to determine the appropriate allocation for one or more subscribers. The allocation must be communicated so a corporation can assign contractual obligations for subscribers to their identified wireless telecommunication service providers (carriers). The allocation identifies the following for each subscriber in every project or implementation:
The appropriate rate plan along with corresponding carrier
The financial impact of the selected plan (cost, savings potential, cost increase, cost decrease, cost per minute, discount impact)
The time length of the contract
Indication if the subscriber's allocated rate plan is different from their historical rate plan
Any transition fees that may apply—cost of activating a new plan, the cost of terminating a previous plan and any handset requirements in terms of cost
Any conditional discount values in terms of subscribers and costs
Analysis against all historical points of interest

The allocation identifies the following for subscribers that have been pooled:
The identity of the subscribers that have been pooled
What kind of pooling plan that represents their rate plan
The pooling group they belong to along with the other subscribers in the same pooling group
The financial cost of pooling
The pooled groups for all associated carriers

The results of the allocation will reflect changes for a given subscriber:

If carrier switching has occurred—the MIP formulation can guide the MIP solver to automatically generate the necessary information that is given to the incumbent carrier to deactivate the subscriber's service.

If a subscriber keeps their business with their existing carrier or switches to a new carrier, the system automatically generates the necessary information to activate the new service, change the rate plan and details of the existing services or to alter the existing service.

In addition, the foregoing two steps can be automatically generated together so the past, current and future transition plans can be managed in a project format.

If desired, a prior allocation of subscribers to rate plans determined in accordance with the method of one of scenarios described above can subsequently be analyzed to validate whether such allocation is optimal in view of one or more subscriber's usage after said allocation and/or in view of other scenarios that may be applicable.

For example, an allocation of subscriber's to one or more rate plans for a first four-month period can be determined in accordance with the method of one of the above-described scenarios, e.g., plan pooling. Thereafter, a new, similar scenario, e.g., plan pooling, (i.e., a suitable new MIP) can be prepared for a second four-month period, that may or may not include some of the same months as the first four-month period. The cost (projected or actual) of the original allocation can be compared to the anticipated cost of a new allocation resulting from the new scenario to assess whether costs savings can be realized and, if so, the new allocation can be implemented.

Also or alternatively, the costs (projected or actual) of allocations determined according to different scenarios (e.g., plan pooling and buckets of minutes) can be compared to determine which allocation should realize the most savings whereupon said allocation can be implemented.

Also or alternatively, the effect of two or more instances of the same scenario can be compared, where at least one of said scenario instances has one or more conditional discounts, one or more side constraints, and/or the like, different that the other scenario instances to determine the effect said conditional discount(s) and/or side constraint(s) has on the cost of the allocation. If one of such allocations is more cost effective than the other(s), the former allocation can be implemented.

If a new allocation doesn't identify changes that indicate a favorable cost reduction or program restructuring (flat rate plans to pooling plans), then one or more new scenarios with unique side constraints or rules along with selected historical months for comparison may be analyzed for potential cost savings.

In essence, the user selects the months they wish to compare data for analysis and historical cost savings. The allocation will identify if the scenario can generate a savings against the historical data and the analyzed data. This comparison does not have to be a direct comparison of a subscribers historical month(s) of usage and their analyzed month(s) of usage. The analysis can be for the entire program, a group of subscribers (scope) or a single subscriber.

Still further, the computer that implements the present invention can be configured to take as input data regarding subscriber's historical usage and information regarding a number of rate plans and to automatically generate from such input one or more of the above-described scenarios. Each scenario can be automatically processed by the MIP solver running on the computer to determine a solution therefor. The computer can compare two or more thus determined solutions and can automatically output an allocation of the most cost effective solution.

Also or alternatively, a side constraint that requires a minimal savings amount and the time period over which such savings must be realized for one or more subscribers can be included in one or more scenarios. If this side constraint is infeasible, the MIP solver would not generate a corresponding allocation for this scenario. However, if this side constraint is feasible, the MIP solver would generate a corresponding allocation for this scenario.

Lastly, if the computer implementing the present invention determines that a newly generated allocation will cost less than an existing allocation, the new allocation can be output along with the cost savings. Desirably, the computer implementing the present invention is programmed to automatically implement, on a desired time schedule, each new allocation it determines will cost less than a currently implemented allocation. For example, if it is determined that making an allocation change amid a subscription period will cost less, then the computer implementing the present invention will make such change. Alternatively, if it is determined that it costs less delaying making an allocation change until the end of a subscription period, then the computer implementing the present invention will delay making such change until the end of the subscription period.

As can be seen, the present invention enables a number of subscribers to be optimally allocated to two or more rate plans at the same time. Each rate plan can be for voice, data or a combination thereof. While only a few MIP formulations have been described, it is believed that one skilled in the art of MIP formulation could, based on the foregoing disclosure, readily prepare a MIP formulation for each plan, discount, side constraint, etc. described above that can be combined with the illustrated MIP formulations for solution by the MIP solver.

The invention has been described with reference to the preferred embodiments. Obvious modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A method of allocating subscribers to one or more wireless carrier rate plans, the method comprising:
(a) selecting a plurality of wireless voice and/or data carrier rate plans;
(b) determining for each of a plurality of subscribers, said subscriber's historical wireless time usage for each of a number of foregone time intervals;
(c) defining for each combination of subscriber, rate plan, time interval and said subscriber's wireless time usage during said time interval a combination of a unique variable and a cost associated with said wireless usage for said rate plan during said time interval;
(d) combining the combinations determined in step (c);
(e) defining for each combination of subscriber and time interval a first constraint that defines a limit on the allocation of said subscriber to one of said rate plans during said time interval; and
(f) electronically determining as a function of the combination of step (d) and each constraint defined in step (e) an allocation of each subscriber to at least one wireless rate plan.

2. The method of claim 1, wherein step (f) further includes electronically determining a cost associated with said allocation.

3. The method of claim 1, wherein each first constraint includes, for one of the combinations of subscriber and time interval, the additive combination of the corresponding unique variables defined in step (c) for said combination of subscriber and time interval for all of said rate plans.

4. The method of claim 1, wherein in step (f), at least one wireless rate plan is allocated to each combination of subscriber and time interval.

5. The method of claim 1, wherein step (e) further includes:
defining for each subscriber a second constraint that defines a limit on the allocation of said subscriber to no more than one of said rate plans; and
defining for each combination of subscriber and rate plan a set of third constraints, with each third constraint of each set thereof corresponding to one of the time intervals, wherein each set of third constraints define a limit on the allocation of said subscriber to said rate plan during all of the time intervals, whereupon in response to step (f) each subscriber is allocated to only one of the rate plans during all of the time intervals

6. The method of claim 1, wherein each time interval is either a month or a billing period of one of the wireless carriers.

7. A method of allocating subscribers to a wireless carrier rate plan, the method comprising:
(a) selecting a plurality of wireless voice and/or data carrier rate plans;
(b) determining for each of a plurality of subscribers, said subscriber's historical wireless time usage for each of a number of foregone time intervals;
(c) defining for each combination of subscriber and rate plan, a combination of a unique variable and a cost associated with said subscriber's wireless usage under said rate plan during all of said time intervals;
(d) defining for each time interval, a combination of a unique variable associated with the overage usage of all of the subscribers in said time interval and a cost associated with each unit of overage usage;
(e) combining the combinations determined in steps (c) and (d);
(f) defining for each subscriber a constraint that includes the unique variables determined for said subscriber in step (c), wherein said constraint defines a limit on the assignment of said subscriber to one of the rate plans;
(g) defining for each combination of subscriber, rate plan and time interval, the combination of surplus or overage units of time that would have been realized by said subscriber during said time interval had said subscriber been subscribed to said rate plan during said time interval and the corresponding unique variable from step (c) for said combination of subscriber and rate plan, wherein the surplus or overage units of time for each combination of subscriber, rate plan and time interval is determined from the difference between the subscriber's actual units of time usage during said time interval and the units of time that would have been available for use during said time interval under said rate plan had said subscriber been subscribed to said rate plan during said time interval;
(h) defining for each time interval, a constraint that requires the sum of the combinations defined in step (g) for said time interval and the variable defined in step (d) for said time interval to be greater than or equal to zero; and
(i) electronically determining as a function of the combination of step (e) and the constraints determined steps (f) and (h) an allocation of all of the subscribers to one of the rate plans.

8. The method of claim 7, wherein step (i) further includes electronically determining a cost associated with said allocation.

9. The method of claim 7, wherein each rate plan is one where the subscribers assigned thereto share the units of usage of said plan.

10. The method of claim 7, wherein each time interval is either a month or a billing period of one of the wireless carriers.

11. The method of claim 7, further including defining for each subscriber, a unique variable and a cost associated with assigning said subscriber to the add-a-phone rate plan for all of the time intervals, wherein:
each constraint of step (f) includes for the corresponding subscriber the unique variable associated with the cost of assigning said subscriber to the add-a-phone rate plan; and
each constraint of step (h) includes for each subscriber the combination of the unique variable associated with the cost of assigning said subscriber to the add-a-phone rate plan and the surplus or overage units of time that would have been realized by said subscriber during the time interval associated with said constraint had said subscriber been subscribed to said rate plan during said time interval.

12. A method of allocating subscribers to a wireless carrier rate plan, the method comprising:
(a) selecting a plurality of wireless voice and/or data carrier rate plans;
(b) determining for each of a plurality of subscribers, said subscriber's historical wireless time usage for each of a number of foregone time intervals;
(c) determining for each combination of time interval and rate plan, a combination of a unique variable associated with the total units of time of usage by all of said subscribers over that allowed by the rate plan during said time interval and a cost associated with each unit of time of usage over that allowed by the rate plan;
(d) defining for each rate plan, a combination of a unique variable and a cost associated with purchasing the rate plan for all of the time intervals;
(e) combining the combinations determined in steps (c) and (d);
(f) defining for each subscriber a constraint that includes a variable for each rate plan, wherein said constraint limits the assignment of said subscriber to one of the rate plans;
(g) defining for each combination of time interval, subscriber and rate plan, a combination of said subscriber's time usage during said time interval and the variable determined for said subscriber and rate plan in step (f);
(h) defining for each combination of time interval and rate plan a constraint that is a combination of:
(1) each combination defined in step (g) for the corresponding time interval and rate plan;
(2) the combination of the total units of time available under the rate plan during said time interval and the variable determined in step (d) for the rate plan; and
(3) the unique variable determined in step (c);
(i) defining for each rate plan a constraint that conditions the allocation of subscribers to the rate plan upon purchase of the rate plan; and
(j) electronically determining as a function of the combination of step (e) and the constraints determined steps (f), (h) and (i) an allocation of all of the subscribers to one of the rate plans.

13. The method of claim 12, wherein step (j) further includes electronically determining a cost associated with said allocation.

14. The method of claim 12, wherein each constraint defined in step (h) includes each combination of step (1) subtracted from the sum of the combinations of steps (2) and (3).

15. The method of claim 12, wherein the constraint defined in step (i) for each rate plan includes the variables of step (f) subtracted from the product of 2 times the variable determined in step (d).

16. A method of allocating subscribers to one or more wireless carrier rate plans, the method comprising:
(a) receiving an allocation of a plurality of subscribers to at least one wireless carrier rate plan, wherein said allocation is determined by the method or either claim 1, claim 7 or claim 12; and
(b) subscribing a subset of said subscribers to said at least one wireless carrier rate plan based on the received allocation.

17. A method of allocating subscribers to one or more wireless carrier rate plans, the method comprising:
(a) selecting a plurality of wireless voice and/or data carrier rate plans;
(b) determining for each of a plurality of subscribers, said subscriber's historical wireless time usage for each of a number of foregone time intervals;
(c) determining for each combination of subscriber and rate plan a first expression that includes a product of a unique variable and a cost associated with assigning said subscriber to said rate plan for at least one of said time intervals;
(d) determining a plurality of constraints that collectively (1) ensure that one rate plan is allocated to all of the subscribers or (2) enable any rate plan to be allocated to each subscriber, wherein each constraint includes a sum of expressions each of which includes at least one of the unique variables determined in step (c);
(e) entering the expressions and the constraints determined in steps (c) and (d), respectively, into a mixed integer program (MIP) solver residing on computer;
(f) causing the computer to execute the MIP solver to minimize the entered expressions as a function the entered constraints, whereupon the MIP solver assigns a binary value of 0 or 1 to each unique variable; and
(g) subscribing each subscriber to a rate plan as a function of the binary value assigned to each unique variable associated with said subscriber.

18. The method of claim 17, wherein:
in step (c) each expression is for all of said time intervals;
step (c) further includes determining for each time interval a second expression that includes the combination of a unique variable associated with overage units of time that would have realized by all of the subscribers under said rate plan during said time interval and a cost of each overage unit of time; and
for each time interval a corresponding constraint is determined therefor in step (d) that includes for each combination of subscriber and rate plan a third expression that is the product of the unique variable associated with said combination in step (c) and the surplus or overage units of time that said subscriber would have realized under said rate plan during said time interval, said constraint further including a sum of all of the third expressions and the unique variable of the second expression determined for said time interval.

19. The method of claim 17, wherein:
in step (c) each first expression is for all of said time intervals;
step (c) further includes determining for each combination of time interval and rate plan a second expression that includes the product of a unique variable associated with overage units of time that would have realized by all of the subscribers under said rate plan during said time interval and a cost for each overage unit of time
step (c) further includes determining for each rate plan a third expression that includes a product of a unique variable and a cost to purchase said rate plan for all of said time intervals;
for each combination of time interval and rate plan a corresponding constraint is determined therefor in step (d) that includes for each subscriber during said time interval a fourth expression that is the product of the unique variable associated in step (c) with said subscriber for the rate plan associated with said constraint and the units of time utilized by said subscriber during said time interval, said constraint further including a sum of (1) all of said fourth expressions, (2) the unique variable associated with overage units of time that would have realized by all of the subscribers under said rate plan during said time interval, and (3) a product of the unique variable of the third expression and the total units of time available under said rate plan during said time interval.
